(19) United States
(12) Patent Application Publication
(10) Pub. No.: US 2005/0028341 A1
(43) Pub. Date: Feb. 10, 2005

(54) Method of manufacturing a combined driveshaft tube and yoke assembly

(76) Inventors: Robert D. Durand, Lancaster, PA (US); Nelson Wagner, Holland, OH (US); Matthew P. Blecke, Toledo, OH (US); Leon W. Valencic, Holland, OH (US); Frederic J. Mahler, Maumee, OH (US)

Correspondence Address: MACMILLAN SOBANSKI & TODD, LLC;ONE MARITIME PLAZA FOURTH FLOOR, 720 WATER STREET, TOLEDO, OH, 43604-1619, US

(21) Appl. No.: 10/878,651

(22) Filed: Jun. 28, 2004

Related U.S. Application Data
(60) Provisional application No. 60/484,087, filed on Jul. 1, 2003.

(51) Int. Cl. F16D 3/16; F16D 3/20

(52) U.S. Cl. 29/421.1; 29/505; 29/506; 29/507

(57) ABSTRACT

A method for manufacturing a combined driveshaft tube and yoke assembly includes the initial step of providing a workpiece having a first end portion, a central portion, and a second end portion. The workpiece may have a varying wall thickness, such as by providing the first end portion and the second end portion with a first wall thickness and the central portion with a second wall thickness that is greater than the first wall thickness. If desired, the central portion of the workpiece may be provided with a ridge that extends about the circumference thereof. Additionally, the central portion of the workpiece may be provided with a plurality of protrusions. The workpiece may be hollow can be deformed to the desired shape by hydroforming or magnetic pulse forming. The central portion of the workpiece is divided, such as along the circumferential ridge, to provide a pair of combined driveshaft tube and yoke assemblies. Also, portions of the protrusions can be removed to provide a plurality of openings in each of the pair of combined driveshaft tube and yoke assemblies.

### CROSS-REFERENCE TO RELATED APPLICATIONS

This application claims the benefit of U.S. Provisional Application No. 60/484,087, filed Jul. 1, 2003, the disclosure of which is incorporated herein by reference.

### BACKGROUND OF THE INVENTION

This invention relates in general to drive train systems for transferring rotational power from a source of rotational power to a rotatably driven mechanism. In particular, this invention relates to an improved method for manufacturing a combined driveshaft tube and yoke assembly for use in such a drive train system.

Drive train systems are widely used for generating power from a source and for transferring such power from the source to a driven mechanism. Frequently, the source generates rotational power, and such rotational power is transferred from the source to a rotatably driven mechanism. For example, in most land vehicles in use today, an engine/transmission assembly generates rotational power, and such rotational power is transferred from an output shaft of the engine/transmission assembly through a driveshaft assembly to an input shaft of an axle assembly so as to rotatably drive the wheels of the vehicle. To accomplish this, a typical driveshaft assembly includes a hollow cylindrical driveshaft tube having a pair of end fittings, such as a pair of tube yokes, secured to the front and rear ends thereof. The front end fitting forms a portion of a front universal joint that connects the output shaft of the engine/transmission assembly to the front end of the driveshaft tube. Similarly, the rear end fitting forms a portion of a rear universal joint that connects the rear end of the driveshaft tube to the input shaft of the axle assembly. The front and rear universal joints provide a rotational driving connection from the output shaft of the engine/transmission assembly through the driveshaft assembly to the input shaft of the axle assembly, while accommodating a limited amount of angular misalignment between the rotational axes of these three shafts.

As mentioned above, a typical driveshaft assembly includes a hollow cylindrical driveshaft tube having a pair of end fittings, such as a pair of tube yokes, secured to the front and rear ends thereof. Traditionally, the tube yokes have been formed by forging or casting and have been secured to the ends of the driveshaft by welding or adhesives. Although this method has been effective, it would be desirable to provide an improved method for manufacturing a combined driveshaft tube and yoke assembly for use in a drive train system that avoids the use of welding or adhesives.

### SUMMARY OF THE INVENTION

This invention relates to an improved method for manufacturing a combined driveshaft tube and yoke assembly, such as for use in a vehicular drive train system. Initially, a workpiece is provided having a first end portion, a central portion, and a second end portion. The workpiece may have a varying wall thickness, such as by providing the first end portion and the second end portion with a first wall thickness and the central portion with a second wall thickness that is greater than the first wall thickness. If desired, the central portion of the workpiece may be provided with a ridge that extends about the circumference thereof. Additionally, the central portion of the workpiece may be provided with a plurality of protrusions. The workpiece may be hollow can be deformed to the desired shape by hydroforming or magnetic pulse forming. The central portion of the workpiece is divided, such as along the circumferential ridge, to provide a pair of combined driveshaft tube and yoke assemblies. Also, portions of the protrusions can be removed to provide a plurality of openings in each of the pair of combined driveshaft tube and yoke assemblies.

Various objects and advantages of this invention will become apparent to those skilled in the art from the following detailed description of the preferred embodiments, when read in light of the accompanying drawings.

### BRIEF DESCRIPTION OF THE DRAWINGS

FIG. 1 is a perspective view of a workpiece that can be used to form a combined driveshaft tube and yoke assembly in accordance with a first embodiment of the method of this invention.

FIG. 2 is a perspective view similar to FIG. 1 showing the workpiece after an initial deformation step has been completed.

FIG. 3 is a sectional elevational view of the deformed workpiece illustrated in FIG. 2.

FIG. 4 is a sectional elevational view similar to FIG. 3 showing the deformed workpiece after a material removing step has been completed to form two combined driveshaft tube and yoke assemblies.

FIG. 5 is a sectional elevational view of one of the combined driveshaft tube and yoke assemblies illustrated in FIG. 4 shown externally secured to a splined member.

FIG. 6 is a sectional elevational view of one of the combined driveshaft tube and yoke assemblies illustrated in FIG. 4 shown internally secured to a splined member.

FIG. 7 is a sectional elevational view of one of the combined driveshaft tube and yoke assemblies illustrated in FIG. 4 shown externally secured to a flange member.

FIG. 8 is a sectional elevational view of one of the combined driveshaft tube and yoke assemblies illustrated in FIG. 4 shown internally secured to a flange member.

FIG. 9 is a perspective view of a workpiece that can be used to form a combined driveshaft tube and yoke assembly in accordance with a second embodiment of the method of this invention.

FIG. 10 is a perspective view similar to FIG. 9 showing the workpiece after an initial deformation step has been completed.

FIG. 11 is a sectional elevational view of the deformed workpiece illustrated in FIG. 10.

FIG. 12 is a sectional elevational view similar to FIG. 11 showing an alternative structure for the workpiece after the initial deformation step has been completed.

FIG. 13 is a sectional elevational view similar to FIG. 12 showing a pair of openings formed through the deformed workpiece and a pair of bearing bushings disposed in such inserts.

FIG. 14 is a sectional elevational view similar to FIG. 12 showing a pair of bushing-shaped openings formed through the deformed workpiece.

### DETAILED DESCRIPTION OF THE PREFERRED EMBODIMENTS

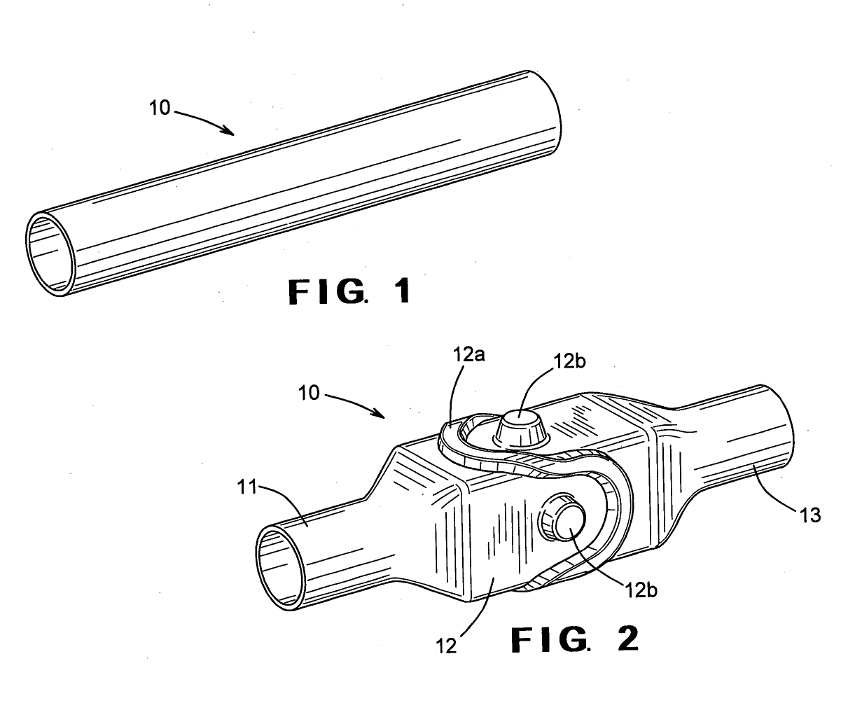

Referring now to the drawings, there is illustrated in FIG. 1 a workpiece, indicated generally at 10, that can be used to form a combined driveshaft tube and yoke assembly in accordance with a first embodiment of the method of this invention. The workpiece 10 is, of itself, conventional in the art, being generally hollow and cylindrical in shape and having a generally uniform wall thickness. However, the workpiece 10 may be provided having any desired shape and may have a varying wall thickness along the length thereof, as discussed further below. Preferably, however, the workpiece 10 is formed from a metallic material that is suitable for deformation by any of a variety of well know metal deformation techniques, such as by hydroforming, magnetic pulse forming, and the like. However, the workpiece 10 may be formed from any desired material that is capable of being re-shaped in a desired manner.

FIG. 2 illustrates the workpiece 10 after it has been subjected to an initial deformation process to re-shape it to a desired configuration. As shown therein, the deformed workpiece 10 includes a first end portion 11, a central portion 12, and a second end portion 13. In the illustrated embodiment, the central portion 12 is somewhat larger in dimension than the first and second end portions 11 and 13, although such is not required. Also, in the illustrated embodiment, the central portion 12 has a generally rectangular cross sectional shape relative to the circular cross sectional shape of the first and second end portions 11 and 13, although again such is not required.

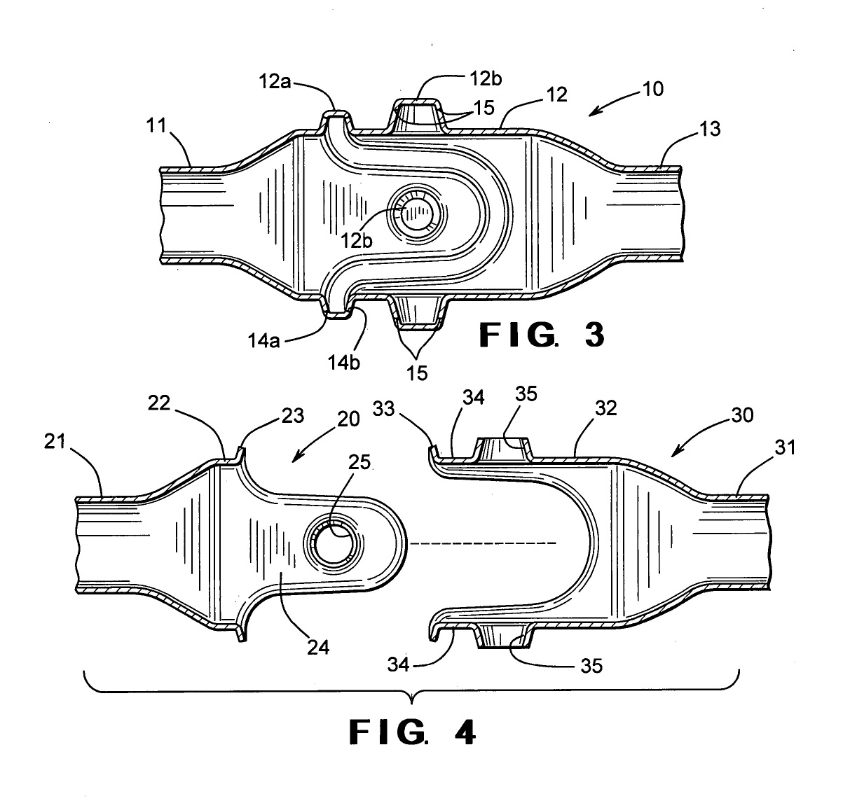

The central portion 12 of the workpiece 10 is preferably deformed in such a manner as to have an outwardly extending ridge 12a formed thereon, although such is not required. In the illustrated embodiment, the ridge 12a is generally U-shaped in cross section (see FIG. 3). However, the ridge 12a may be formed having any desired cross sectional shape. The illustrated ridge 12a extends completely about the circumference of the central portion 12 of the workpiece 10. However, the ridge 12a need not extend completely about the circumference of the central portion 12 of the workpiece 10. Alternatively, the ridge 12a may be embodied as two or more discontinuous structures (not shown) that together extend about some or all of the circumference of the central portion 12 of the workpiece 10. Furthermore, the illustrated ridge 12a is generally sinusoidal in shape as it extends about the circumference of the central portion 12 of the workpiece 10. However, the ridge 12a may be formed having any desired shape as it extends about the circumference of the central portion 12 of the workpiece 10. The purpose for the ridge 12a will be explained below.

Additionally, the central portion 12 of the workpiece 10 is preferably deformed in such a manner as to have a plurality of outwardly extending protrusions 12b formed thereon. In the illustrated embodiment, each of the protrusions 12b is generally cup-shaped in cross section (see FIG. 3) However, the protrusions 12b may be formed having any desired cross sectional shape. In the illustrated embodiment, four of such protrusions 12b are provided in two opposed pairs, one on each of the four sides of the rectangularly-shaped central portion 12 of the workpiece 10. However, any desired number of such protrusions 12b may be provided at any desired locations on the central portion 12 of the workpiece 10. The purpose for the protrusions 12b will also be explained below.

Following the initial deformation process as described above, the workpiece 10 is subjected to a material removing process. In the illustrated embodiment, the ridge 12a of the workpiece 10 is cut along two lines 13 and 14 (see FIG. 3) throughout the sinusoidal circumference thereof. These cuts in the ridge 12a can be accomplished by any desired material removing process, such as by laser cutting or mechanical machine cutting. As a result such cuttings, the workpiece 10 is divided into a pair of combined driveshaft tube and yoke assemblies, such as indicated generally at 20 and 30 in FIG. 4. The short strip of material that extends between the two cuts 13 and 14 can be discarded as scrap. Alternatively, the ridge 12a of the workpiece 10 can be shaped in such a manner as to facilitate a cut being along a single line, whereby no strip of scrap is generated. Similarly, each of the protrusions 12b is cut along a line 15 (see FIG. 3) to remove a portion thereof, such as the circular outer portion.

The first combined driveshaft tube and yoke assembly 20 formed by the material removing process described above includes a hollow cylindrical end portion 21 (defined by the first end portion 11 of the workpiece 10 described above) and an enlarged yoke portion 22 (defined by part of the deformed central portion 12 of the workpiece 10 described above). The yoke portion 22 has an outwardly-extending flange 23 formed circumferentially thereabout that can enhance the strength and stiffness thereof, although such is not required. A pair of yoke arms 24 (only one is illustrated) extend generally axially from the yoke portion 22. Each of the yoke arms 24 has an opening, such as a flanged opening 25, formed therethrough (each opening 25 being defined by part of the protrusions 12b of the workpiece 10 described above), and such flanged openings 25 are preferably co-axially aligned with one another. Similarly, the second combined driveshaft tube and yoke assembly 30 formed by the material removing process described above includes a hollow cylindrical end 31 (defined by the second end portion 13 of the workpiece 10 described above) and an enlarged yoke portion 32 (defined by part of the central portion 12 of the deformed workpiece 10 described above). The yoke portion 32 has an outwardly-extending flange 33 formed circumferentially thereabout that can enhance the strength and stiffness thereof, although such is not required. A pair of yoke arms 34 extend generally axially from the yoke portion 32. Each of the yoke arms 34 has an opening, such as a flanged opening 35, formed therethrough (each opening 35 being defined by part of the protrusions 12b of the workpiece 10 described above), and such flanged openings 35 are preferably co-axially aligned with one another.

Following their formation in the manner described above, each of the combined driveshaft tube and yoke assemblies 20 and 30 can be subjected to one or more finishing operations to precisely define the shapes thereof. When finished, each of the combined driveshaft tube and yoke assemblies 20 and 30 can function as a conventional combined driveshaft and yoke assembly. For example, the two combined driveshaft tube and yoke assemblies 20 and 30 can be connected together by a conventional universal joint cross (not shown) to provide two driveshaft sections having a rotational driving connection therebetween that can accommodate a limited amount of angular misalignment between the rotational axes thereof. Typically, the cross includes a central body portion with four cylindrical trunnions extending outwardly therefrom. The trunnions are oriented in a single plane and extend at right angles relative to one another. A hollow cylindrical bearing cup is mounted on the end of each of the trunnions. Needle bearings or other friction-reducing structures are provided between the outer cylindrical surfaces of the trunnions and the inner cylindrical surfaces of the bearing cups to permit rotational movement of the bearing cups relative to the trunnions during operation of the universal joint. The bearing cups supported on the first opposed pair of the trunnions on the cross can be received within the aligned openings 25 formed through the yoke arms 24 of the first combined driveshaft tube and yoke assembly 20, while the bearing cups supported on the second opposed pair of the trunnions on the cross can be received within the aligned openings 35 formed through the yoke arms 34 of the second combined driveshaft tube and yoke assembly 30.

Alternatively, the hollow cylindrical end 21 of the first driveshaft tube and yoke assembly 20 can be connected to the hollow cylindrical end 31 of the second driveshaft tube and yoke assembly 30 to form a conventional driveshaft assembly, i.e., a driveshaft tube having first and second yokes at the opposed ends thereof. The hollow cylindrical ends 21 and 31 of the first and second driveshaft tube and yoke assemblies 20 and 30, respectively, can be secured together in any desired manner, such as by welding. Alternatively, the hollow cylindrical ends 21 and 31 of the first and second driveshaft tube and yoke assemblies 20 and 30 can have respective splined portions either secured thereto or formed integrally therewith to provide a rotational driving connection therebetween, while accommodating a limited amount of relative axial movement.

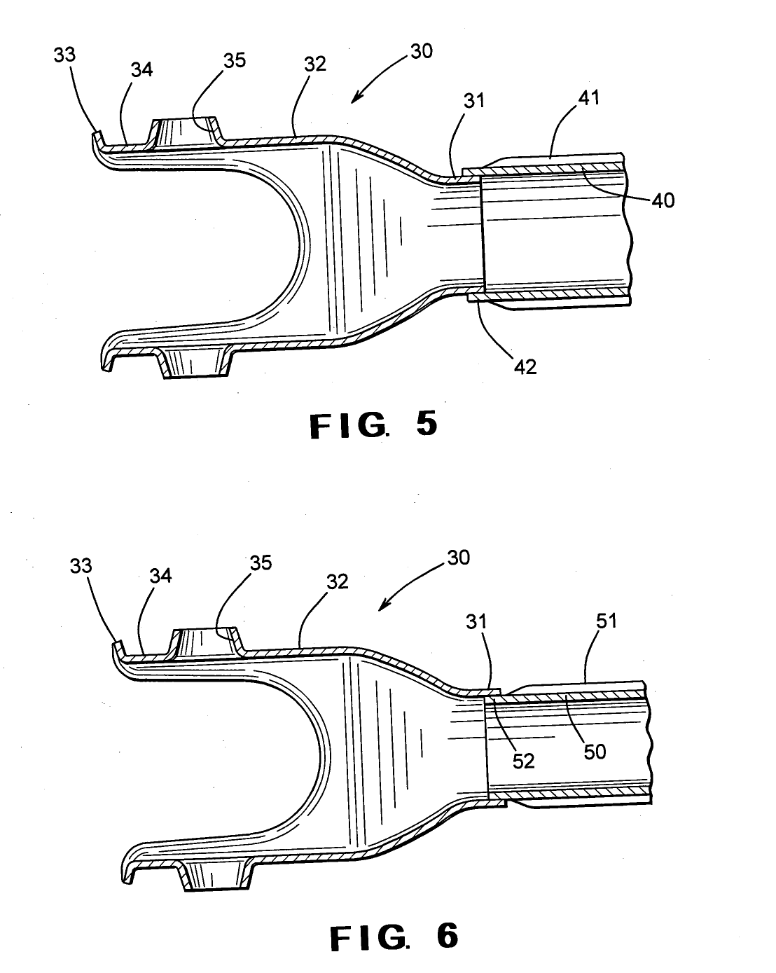

FIG. 5 is a sectional elevational view of the second driveshaft tube and yoke assembly 30 illustrated in FIG. 4 shown externally secured to a splined member, such as a splined stub shaft 40. The stub shaft 40 is generally hollow and cylindrical in shape, having a plurality of splines 41 provided thereon. In the illustrated embodiment, the splines 41 extend outwardly from the outer surface of the stub shaft 40, thus providing a male splined member. However, it will be appreciated that the splines 41 can extend inwardly from the inner surface of the stub shaft 40, thus providing a female splined member. An end portion 42 of the stub shaft 40 extends circumferentially about part of the hollow cylindrical end portion 31 of the second driveshaft tube and yoke assembly 30 and is secured thereto by any desired means. For example, the end portion 42 of the stub shaft 40 can be secured to the hollow cylindrical end portion 31 of the second driveshaft tube and yoke assembly 30 by magnetic pulse welding, conventional welding (such as laser welding, electron beam welding, and the like), adhesives, and the like, to provide a conventional slip yoke or similar structure.

FIG. 6 is a sectional elevational view of the second driveshaft tube and yoke assembly 30 illustrated in FIG. 4 shown internally secured to a splined member, such as a splined stub shaft 50. The stub shaft 50 is generally hollow and cylindrical in shape, having a plurality of splines 51 provided thereon. In the illustrated embodiment, the splines 51 extend outwardly from the outer surface of the stub shaft 50, thus providing a male splined member. However, it will be appreciated that the splines 51 can extend inwardly from the inner surface of the stub shaft 50, thus providing a female splined member. An end portion 52 of the stub shaft 50 extends circumferentially within part of the hollow cylindrical end portion 31 of the second driveshaft tube and yoke assembly 30 and is secured thereto by any desired means. For example, the end portion 52 of the stub shaft 50 can be secured to the hollow cylindrical end portion 31 of the second driveshaft tube and yoke assembly 30 by magnetic pulse welding, conventional welding (such as laser welding, electron beam welding, and the like), adhesives, and the like, to provide a conventional slip yoke or similar structure.

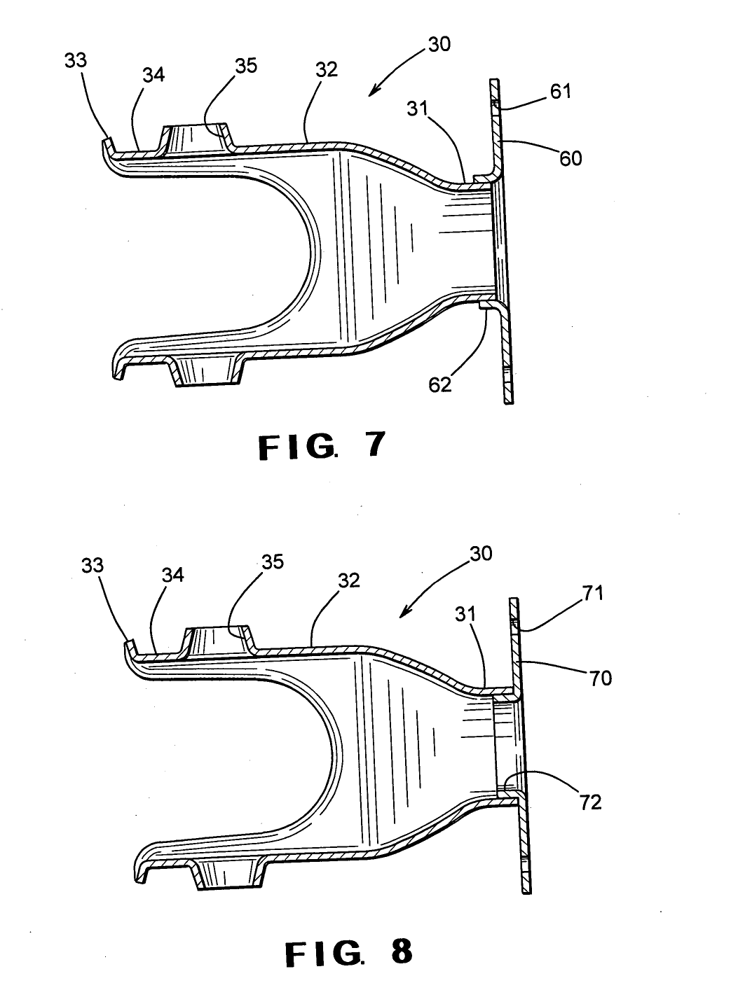

FIG. 7 is a sectional elevational view of the second driveshaft tube and yoke assembly 30 illustrated in FIG. 4 shown externally secured to a flanged member, such as a flange disc 60. The flange disc 60 is generally flat and circular in shape, having a plurality of openings 61 formed therethrough. In the illustrated embodiment, the openings 61 extend generally axially through the flange disc 60, although such is not required. An end portion 62 of the flange disc 60 extends circumferentially about part of the hollow cylindrical end portion 31 of the second driveshaft tube and yoke assembly 30 and is secured thereto by any desired means. For example, the end portion 62 of the flange disc 60 can be secured to the hollow cylindrical end portion 31 of the second driveshaft tube and yoke assembly 30 by magnetic pulse welding, conventional welding (such as laser welding, electron beam welding, and the like), adhesives, and the like, to provide a conventional flange yoke or similar structure.

FIG. 8 is a sectional elevational view of the second driveshaft tube and yoke assembly 30 illustrated in FIG. 4 shown internally secured to a flanged member, such as a flange disc 70. The flange disc 70 is generally flat and circular in shape, having a plurality of openings 71 formed therethrough. In the illustrated embodiment, the openings 71 extend generally axially through the flange disc 70, although such is not required. An end portion 72 of the flange disc 70 extends circumferentially about part of the hollow cylindrical end portion 31 of the second driveshaft tube and yoke assembly 30 and is secured thereto by any desired means. For example, the end portion 72 of the flange disc 70 can be secured to the hollow cylindrical end portion 31 of the second driveshaft tube and yoke assembly 30 by magnetic pulse welding, conventional welding (such as laser welding, electron beam welding, and the like), adhesives, and the like, to provide a conventional flange yoke or similar structure.

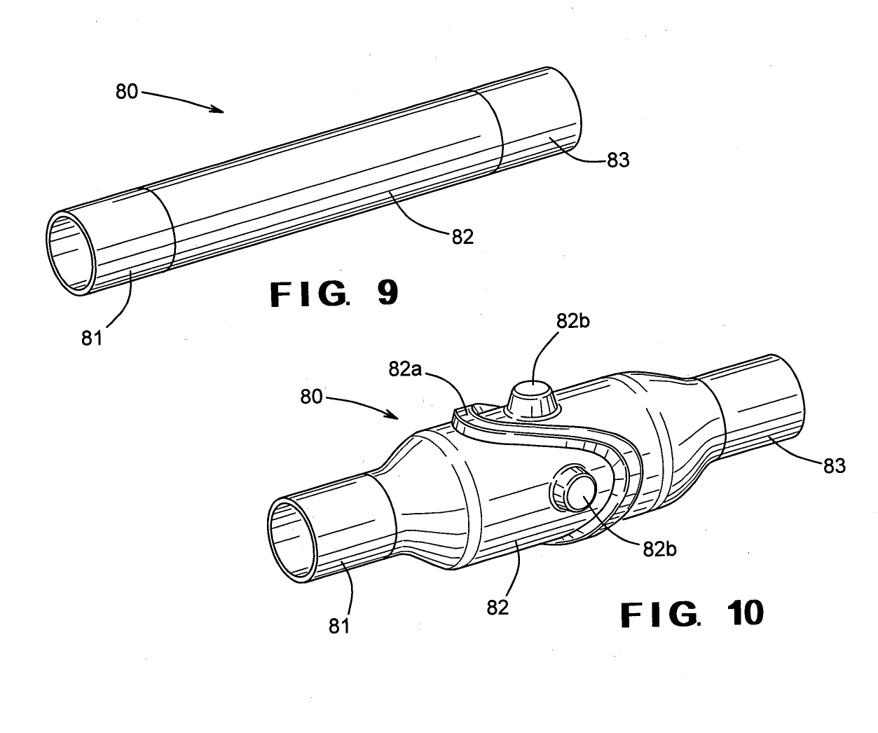

Referring now to FIGS. 9, 10, and 11, there is illustrated a workpiece, indicated generally at 80, that can be used to form a driveshaft assembly in accordance with a second embodiment of the method of this invention. The workpiece 80 is, of itself, conventional in the art, being generally hollow and cylindrical in shape. The workpiece 80 is formed from three sections 81, 82, and 83 that are joined together in an end-to-end manner. In the illustrated embodiment, the three sections 81, 82, and 83 have the same outer diameter so that the outer diameter of the workpiece 80 is constant from one end to the other. However, the outer diameters of the three sections 81, 82, and 83 may differ from one another as desired. As will become apparent below, the wall thicknesses of both of the first and third sections 81 and 83 of the workpiece 80 are smaller than the wall thickness of the second section 82. However, the wall thicknesses of the three sections 81, 82, and 83 may be the same or differ otherwise from one another as desired. The three sections 81, 82, and 83 may be secured together by any conventional process, such as by welding. Preferably, however, the workpiece 80 is formed from a metallic material that is suitable for deformation by any of a variety of well know metal deformation techniques, such as by hydroforming, magnetic pulse forming, and the like. However, the workpiece 80 may be formed from any desired material that is capable of being re-shaped in a desired manner.

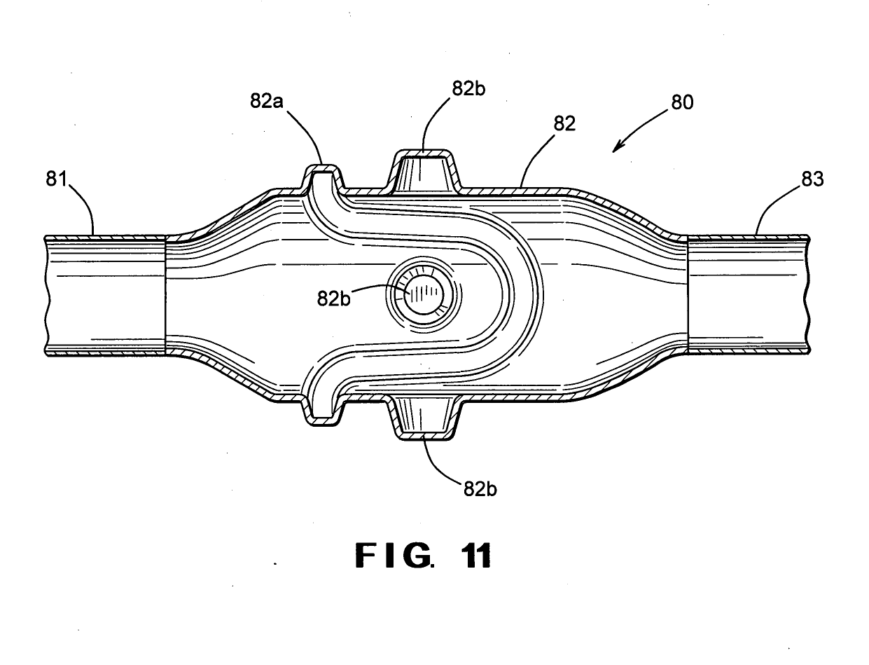

FIGS. 10 and 11 illustrate the workpiece 80 after it has been subjected to an initial deformation process to re-shape it to a desired configuration. As shown therein, the deformed workpiece 80 includes a first end portion 81, a central portion 82, and a second end portion 83. In the illustrated embodiment, the central portion 82 is somewhat larger in dimension than the first and second end portions 81 and 83, although such is not required. Also, in the illustrated embodiment, the central portion 82 has a generally rectangular cross sectional shape relative to the circular cross sectional shape of the first and second end portions 81 and 83, although again such is not required.

The central portion 82 of the workpiece 80 is preferably deformed in such a manner as to have an outwardly extending ridge 82a formed thereon, although such is not required. In the illustrated embodiment, the ridge 82a is generally U-shaped in cross section (see FIG. 11). However, the ridge 82a may be formed having any desired cross sectional shape. The illustrated ridge 82a extends completely about the circumference of the central portion 82 of the workpiece 80. However, the ridge 82a need not extend completely about the circumference of the central portion 12 of the workpiece 80. Alternatively, the ridge 82a may be embodied as two or more discontinuous structures (not shown) that together extend about some or all of the circumference of the central portion 82 of the workpiece 80. Furthermore, the illustrated ridge 82a is generally sinusoidal in shape as it extends about the circumference of the central portion 82 of the workpiece 80. However, the ridge 82a may be formed having any desired shape as it extends about the circumference of the central portion 82 of the workpiece 80.

Additionally, the central portion 82 of the workpiece 80 is preferably deformed in such a manner as to have a plurality of outwardly extending protrusions 82b formed thereon. In the illustrated embodiment, each of the protrusions 82b is generally cup-shaped in cross section (see FIG. 11) However, the protrusions 82b may be formed having any desired cross sectional shape. In the illustrated embodiment, four of such protrusions 82b are provided in two opposed pairs, one on each of the four sides of the rectangularly-shaped central portion 82 of the workpiece 80. However, any desired number of such protrusions 82b may be provided at any desired locations on the central portion 82 of the workpiece 80.

Following the initial deformation process as described above, the workpiece 80 is subjected to a material removing process. In the illustrated embodiment, the ridge 82a of the workpiece 80 is cut along two lines in the manner described above throughout the sinusoidal circumference thereof. These cuts in the ridge 82a can be accomplished by any desired material removing process, such as by laser cutting or mechanical machine cutting. As a result such cuttings, the workpiece 80 can be divided into a pair of combined driveshaft tube and yoke assemblies, similar to the combined driveshaft tube and yoke assemblies 20 and 30 in FIG. 4. Similarly, each of the protrusions 82b can be cut along a line in the manner described above to remove a portion thereof, such as the circular outer portion.

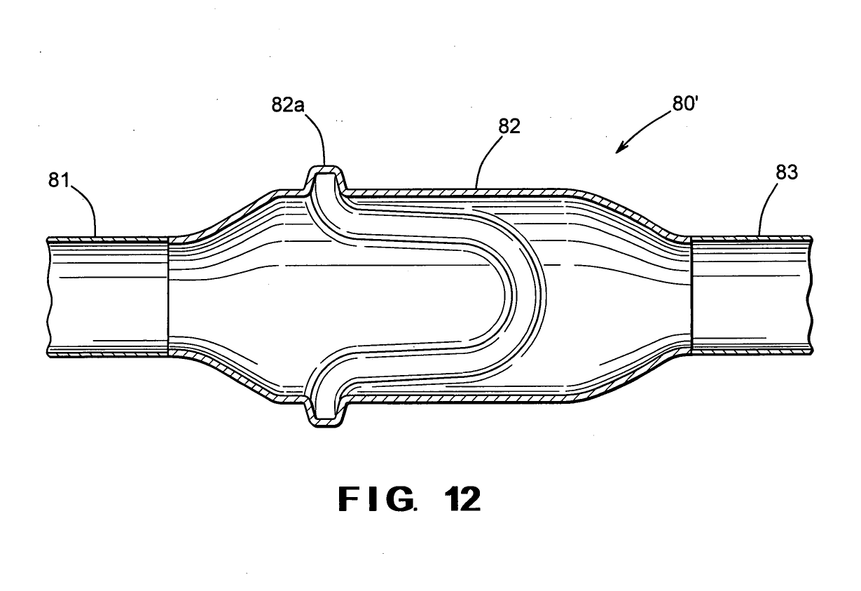

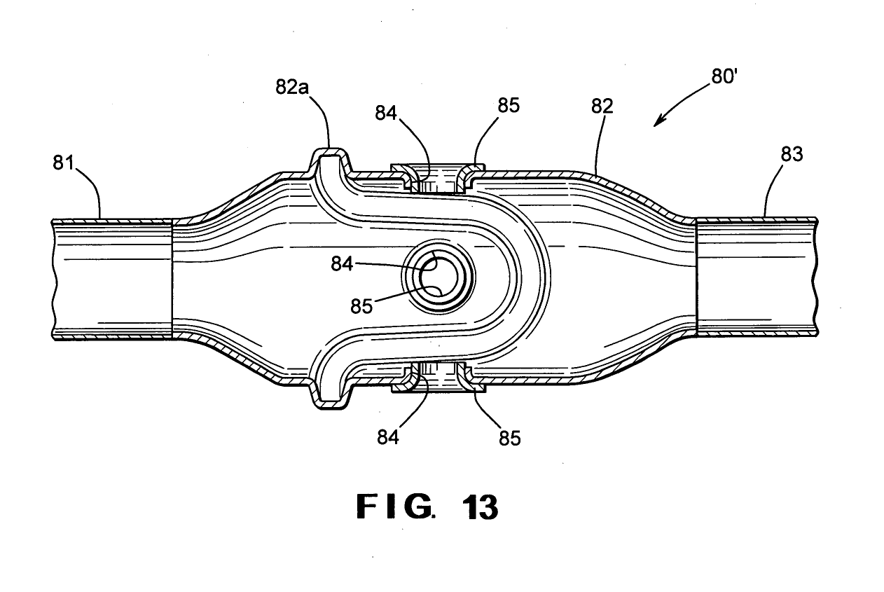

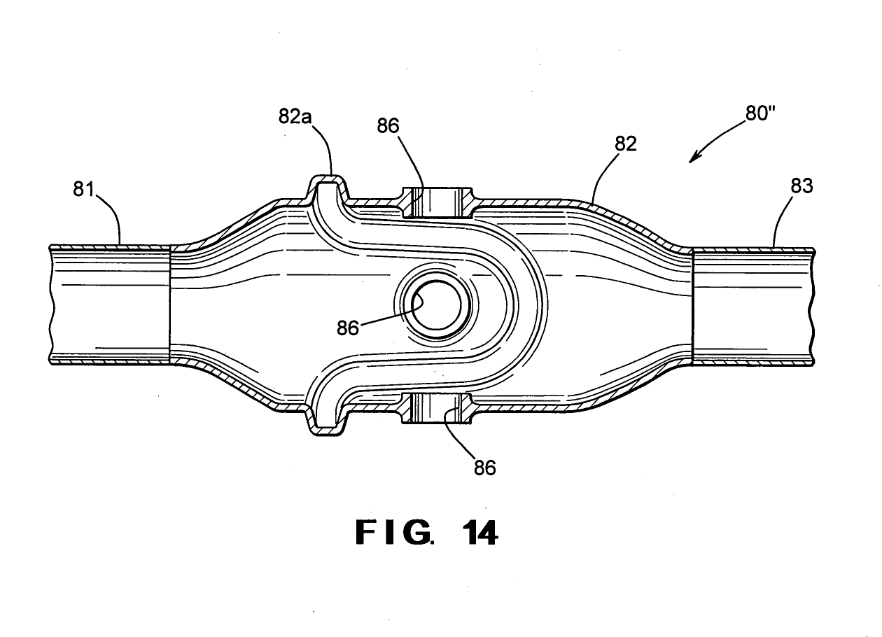

FIGS. 12, 13, and 14 illustrates alternative structures for the workpiece 80′ after the initial deformation step has been completed. As shown in FIG. 12, the deformed workpiece 80′ is similar to the deformed workpiece 80 described above, and like reference numbers are used to indicate similar structures. In this embodiment, however, none of the protrusions 82b are formed in the second section 82 of the workpiece 80′. Rather, as shown in FIG. 13, a plurality of openings 84 can be formed through the second section 82 of the workpiece 80′ in the same locations as where the protrusions 82a were formed in the workpiece 80. The openings 84 can be formed using any desired process, such as by a conventional T-drilling process. A bearing bushing 85 is disposed within each of the openings 84 to receive and support the bearing cups of the universal joint cross, as described above. Alternatively, as shown in FIG. 14, a plurality of flange openings 86 can be formed through the second section 82 of the workpiece 80′ in the same locations as where the protrusions 82a were formed in the workpiece 80. The flanged openings 86 can be formed using any desired process, such as by a conventional flow drilling process. The flanged openings 86 directly receive and support the bearing cups of the universal joint cross, as described above.

In accordance with the provisions of the patent statutes, the principle and mode of operation of this invention have been explained and illustrated in its preferred embodiments. However, it must be understood that this invention may be practiced otherwise than as specifically explained and illustrated without departing from its spirit or scope.

1. A method for manufacturing a combined driveshaft tube and yoke assembly comprising the steps of:
(a) providing a workpiece to have a first end portion, a central portion, and a second end portion;
(b) dividing the central portion of the workpiece to provide a pair of combined driveshaft tube and yoke assemblies.

2. The method defined in claim 1 wherein said step (a) is performed by providing a hollow workpiece and deforming the workpiece by one of hydroforming and magnetic pulse forming to have the first end portion, the central portion, and the second end portion.

3. The method defined in claim 1 wherein said step (a) is performed by providing the central portion of the workpiece with a ridge, and wherein said step (b) is performed by dividing the central portion of the workpiece along the ridge to provide the pair of combined driveshaft tube and yoke assemblies.

4. The method defined in claim 1 wherein said step (a) is performed by providing the central portion of the workpiece with a plurality of protrusions, and wherein said step (b) includes the step of removing portions of the protrusions to provide a plurality of openings in each of the pair of combined driveshaft tube and yoke assemblies.

5. The method defined in claim 1 including the further step (c) of securing one of a splined member and a flange member to one of the pair of combined driveshaft tube and yoke assemblies.

6. The method defined in claim 5 wherein said step (a) is performed by securing the one of a splined member and a flange member either externally or internally to the one of the pair of combined driveshaft tube and yoke assemblies.

7. The method defined in claim 1 wherein said step (b) includes the further steps of forming a plurality of openings in each of the pair of combined driveshaft tube and yoke assemblies and disposing a bearing bushing in each of the openings.

8. The method defined in claim 1 wherein said step (b) includes the further step of forming a plurality of flanged openings in each of the pair of combined driveshaft tube and yoke assemblies.

9. The method defined in claim 1 wherein said step (a) is performed by providing a workpiece that has a varying wall thickness.

10. The method defined in claim 9 wherein said step (a) is performed by providing a workpiece having the first end portion and the second end portion with a first wall thickness and the central portion with a second wall thickness that is greater than the first wall thickness.
